(19) United States
(12) Patent Application Publication
(10) Pub. No.: US 2004/0145089 A1
(43) Pub. Date: Jul. 29, 2004

(54) Uv-curable inks for ptf laminates (including flexible circuitry)

(76) Inventor: Kenneth Burrows, Phoenix, AZ (US)

Correspondence Address: Martin Korn, 2200 Ross Avenue, Suite 2200, Dallas, TX, 75201, US

(21) Appl. No.: 10/476,494

(22) PCT Filed: Jun. 19, 2002
(86) PCT No.: PCT/US02/19321

(51) Int. Cl. B05D 5/12; B29C 35/08

(52) U.S. Cl. 264/496; 264/494; 427/66; 427/511

(57) ABSTRACT

A polymer Thick Film (“PTF”) laminate, in which selected (and advantageously all) of the layers are deployed using UV-curable inks. In one embodiment of the invention, the UV-curable PTF layers are deployed in an exemplary monolithic and membranous EL structure, in which UV-cured urethane envelope layers encapsulate UV-cured urethane electroluminescent layers. When deployed in layer form during manufacture and subsequently exposed to UV radiation, the inventive inks cure in a few seconds without any appreciable layer height shrinkage. Manufacturing cycle time is significantly optimized over traditional heat curing processes. Flexible circuitry is also disclosed herein. The flexible circuitry may be embodied using the UV-curable urethane inks disclosed herein, although the flexible circuitry is not limited to UV-curable or urethane embodiments. Successive insulating layers are deployed. The insulating layers have conductive pathways deployed thereon. The conductive pathways may be connected in any way desired on a single layer or between layers. Apertures may be left in insulating layers to receive surface mounted components (“SMCs”) that are in conductive communication with conductive pathways deployed on the layer beneath. Active zones may also be deployed between conductive pathways on a layer. Such active zones comprise inks that, when cured, have predesigned electrical characteristics (such as resistance, capacitance, inductance, semiconductance, etc.) when the conductive pathways are energized. In another embodiment, selected layers in the flexible circuitry comprise conductive pathways, active zones and insulating zones all deployed next to one another to form a single multi-function layer. Use of such multi-function layers enables conductive pathways, active zones and insulating zones to be designed into the flexible circuitry with a dimension that is not limited to the general plane of the deployed layer.

### RELATED APPLICATIONS

This application claims the benefit of U.S. provisional patent application UV-CURABLE INKS FOR PTF LAMINATES (INCLUDING FLEXIBLE CIRCUITRY), Serial No. 60/299,598, filed Jun. 19, 2001.

This application is a continuation-in-part of co-pending, commonly-assigned U.S. patent application MEMBRANOUS EL SYSTEM IN UV-CURED URETHANE ENVELOPE, Ser. No. 09/974,941, filed Oct. 10, 2001.

This application is also a continuation-in-part of co-pending, commonly-assigned U.S. patent application TRANSLUCENT LAYER INCLUDING METAL/METAL OXIDE DOPANT SUSPENDED IN GEL RESIN, Ser. No. 09/173,521, filed Oct. 15, 1998, which is a continuation of commonly-assigned U.S. patent application ELECTROLUMINESCENT SYSTEM IN MONOLITHIC STRUCTURE, Ser. No. 08/656,435, filed May 30, 1996, now U.S. Pat. No. 5,856,029.

This application is also a continuation in part of co-pending, commonly-assigned U.S. patent application METHOD FOR CONSTRUCTION OF ELASTOMERIC ELECTROLUMINESCENT LAMP, Ser. No. 09/173,404, filed Oct. 15, 1998, which is a divisional of commonly-assigned U.S. patent application ELASTOMERIC ELECTROLUMINESCENT LAMP, Ser. No. 08/774,743, filed Dec. 30,1996, now U.S. Pat No. 5,856,030.

### TECHNICAL FIELD OF THE INVENTION

This invention relates, in general, to Polymer Thick Film (“PTF”) laminates of cured inks (such as are useful, for example, in the manufacture of electroluminescent systems), and more specifically to a PTF laminate of UV-curable inks.

### BACKGROUND OF THE INVENTION

As used herein, the term “ink” includes substances understood in the art to have a temporary fluid form so that they may be deployed in a selected way via flow. Once deployed, the ink may be cured to leave a cured layer having desired functionality. The present disclosure is particularly directed to inks that may be cured into polymer thick film (“PTF”) layers.

An embodiment of the invention taught by parent application Ser. No. 09/173,521 is directed to an electroluminescent (“EL”) system having a unitary carrier whose layers form a monolithic structure. A preferred unitary carrier in this system is a vinyl resin. One of the advantages of this monolithic electroluminescent system is that the layers thereof may be deployed as inks onto a wide variety of substrates using screen printing or other suitable methods.

This vinyl-based monolithic structure is also disclosed in an exemplary embodiment of the membranous electroluminescent devices taught by parent application Ser. No. 09/173,404. Specifically, Ser. 09/173,404 teaches exemplary use of the vinyl-based monolithic structure as an electroluminescent laminate deployed between two membranous urethane envelope layers.

While the electroluminescent systems described in Ser. Nos. 09/173,521 and 09/173,404 have been found to be serviceable, it will be appreciated that yet further advantages of monolithic structure will be obtained if the electroluminescent laminate in Ser. No. 09/173,404 had layers suspended in a urethane carrier. In this way, the membranous electroluminescent devices disclosed in Ser. 09/173,404 would comprise layers in the electroluminescent laminate that were in monolithic unity with surrounding urethane envelope layers. Co-pending, concurrently-filed provisional patent application MEMBRANOUS MONOLITHIC EL STRUCTURE WITH URETHANE CARRIER, Serial No. 60/239,507, addresses this need by providing, in an exemplary embodiment, a membranous monolithic urethane electroluminescent structure whose monolithic phase comprises a series of contiguous electroluminescent layers deployed using a unitary vinyl gel resin carrier that is catalyzed to transform into a unitary urethane carrier during curing.

Parent application 60/239,508 discloses that regardless of whether the layers of the electroluminescent system cure to a vinyl or urethane (or any other polymer), however, the surrounding membranous envelope layers had been conventionally heat cured. Typically, in the membranous lamp disclosed in parent application Ser. No. 09/173,404, a heat cure of about 105° for about 35 minutes per deployed urethane envelope layer was required. In a structure having envelope layer thickness built up from several individual urethane layer deployments, the curing phase conventionally required multiples of 35-minute cures, thereby adding significantly to the manufacturing cycle time (and cost) for the structure.

Moreover, as disclosed by parent application 60/239,508, heat curing had been found to cause shrinkage of the height of individually deployed layers. Thus, even more layers were required to be deployed to build up an overall envelope layer height, extending the manufacturing cycle time for curing even further.

Parent application 60/239,508 discloses using a UV-curing process as an alternative to conventional heat curing of the envelope layers in a membranous EL structure. Such a UV alternative advantageously reduces curing cycle times and minimizes individual deployed layer height shrinkage.

1. As the creative use of PTF ink technology proliferates, it will be appreciated that it would be highly advantageous to extend the envelope layer UV-curing process disclosed in parent application 60/239,508 to wider applications. For example, it will be further appreciated that yet further advantages in reduced curing cycle times, as well as other potential benefits, would be available if the layers of the electroluminescent system within the envelope layers disclosed in parent application 60/230,508 could also be UV-cured. Moreover, it will be appreciated that additional advantages and benefits will arise if the monolithic urethane EL structures disclosed in co-pending application 60/239,507 were deployed originally as UV-curable urethane inks. In this way, an entire monolithic and membranous EL structure, including electroluminescent and envelope layers, could be cured with a unitary, rapid curing process.

There is a therefore need in the art for more universal UV-curable inks for use in polymer thick film laminates. Such universal UV-curable inks would not be limited in their applications to just EL structures. Although such universal UV-curable inks would, for example, be advantageous in deploying and curing the electroluminescent and envelope layers in the EL structures disclosed, for example, in parent application 60/230,508 and co-pending application 60/230,507, it will be appreciated that such universal UV-curable inks would also bring advantage to all deployments of PTF laminates, including EL structures as well as non-EL laminates. Included in the group of non-EL laminates would be, for example, PTF laminates with translucent conductive layers, or alternatively PTF laminates providing flexible printed circuitry.

### SUMMARY OF THE INVENTION

The present invention fulfils the above-described goals by providing UV-curable inks for PTF layers. In the embodiments described herein, an EL structure in PTF form includes layers of a carrier comprising of a UV-curable (photo-initiated) acrylate/acrylate monomer. The carrier is selectively doped with active ingredients according to desired layer functionality. One embodiment described herein discloses use of a UV-curable urethane acrylate/acrylate monomer as the carrier for all inks in the deployed laminate. Another embodiment discloses use of a UV-curable epoxy acrylate/acrylate monomer as the carrier in inks requiring high conductivity, such as electrode layers in EL structures. Free radicals in the epoxy acrylate/acrylate monomer are postulated to enhance the conductivity of the deployed layer when cured.

For a membranous EL structure as conceptually disclosed in co-pending, commonly-assigned U.S. application METHOD FOR CONSTRUCTION OF ELASTOMERIC ELECTROLUMINESCENT LAMP, Ser. No. 09/173,404, the advantages of UV-curing are now brought to the envelope layers and/or the electroluminescent layers. In one embodiment of the invention, preferably all layers comprise inks that each include a UV-curable urethane carrier. Alternatively, the back electrode layer may include a UV-curable epoxy carrier. When deployed in layer form and exposed to UV radiation, the inks cure in a few seconds without any appreciable layer height shrinkage. Manufacturing cycle time is significantly optimized over traditional heat curing processes.

In other embodiments of the invention, the UV-cured layers may be deployed in a non-EL laminate such as a PTF laminate with a translucent conductive layer, or in flexible printed circuitry deployed in PTF form.

The optimization of manufacturing cycle time using a UV-cured ink has been recorded to include a reduction of curing cycle times for individually deployed layers from minutes to seconds. In addition to the inherent advantages to manufacturing production brought about by such a reduction in curing cycle time, such a reduction further enables manufacturing in many applications to convert from a batch curing system to a continuous curing system. Embodiments of the present invention may be cured on a UV curing conveyor system as is well known in the art. This is in distinction to heat curing “batches” of EL structures layer by layer in an oven, as is generally undertaken in current manufacturing.

Further, the rapidity with which layers can now be deployed and cured now enables printing of all or selected layers in the EL structure using alternatives to screen printing processes, such as pad printing, roll printing and carousel printing. The advantageous aspects of these alternatives to screen printing are generally well know in the art. For example, pad printing has good application to printing on three-dimensional surfaces, and carousel and roll printing techniques have good application to continuous manufacturing processes. These aspects now become available with the herein-described advantages of the present invention.

Accordingly, a technical advantage of the present invention is that curing cycle times for the inventive inks are dramatically reduced.

A further technical advantage of the present invention is that deployed layer height shrinkage is also reduced. As a result, fewer individually deployed layers are necessary to achieve a desired overall PTF layer thickness.

A further technical advantage of the present invention is that continuous curing techniques are now available to manufacturing processes, in contrast to the batch techniques that are currently available. Additionally, the advantages of conventional continuous printing techniques such as pad printing, carousel printing and roll printing, are now available to PTF layer deployment.

A further technical advantage of the present invention is that a UV-curable ink is now available substantially universally to PTF laminates. The inventive inks thus bring advantages to EL structures in PTF form and non-EL structures in PTF form alike.

A further technical advantage of the present invention is that the UV-curable inks allow membranous and monolithic properties to be brought to PTF laminates created with them. With regard to membranous properties, it has been found that the embodiments disclosed herein show good membranous properties using either an all urethane carrier or a structure with a conductive layer including an epoxy carrier. With regard to monolithic properties it has been found that the embodiments disclosed herein show enhanced monolithic properties wherever neighboring layers are deployed using a common carrier.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a cross-sectional view of a membranous EL structure deployed using UV-curable inks according to the present invention;

FIG. 2 is a perspective view of the cross-sectional view of FIG. 1;

FIG. 3 is a perspective view of a membranous EL lamp of the present invention being peeled off transfer release film 102;

FIG. 4 depicts a preferred method of enabling electric power supply to an membranous EL lamp of the present invention;

FIG. 5 depicts an alternative preferred method of enabling electric power supply to an membranous EL lamp of the present invention;

FIG. 6 depicts zones of membranous EL lamp 300, with a cutaway portion 601, supporting disclosure herein of various colorizing techniques of layers to create selected unlit/lit appearances;

FIG. 7 is a cross-sectional view of a membranous EL structure deployed onto a fibrous or porous substrate (such as fabric) using UV-curable inks according to the present invention; and

FIGS. 8 through 14 are views of flexible circuitry 800 illustrating various aspects thereof as described herein.

### DESCRIPTION OF THE PREFERRED EMBODIMENTS

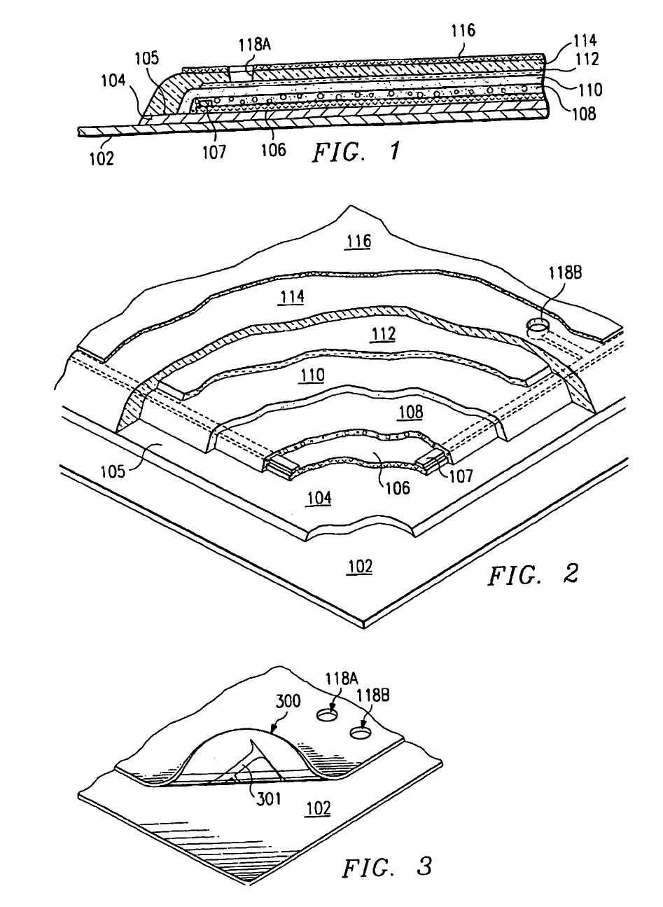

FIG. 1 illustrates a cross-sectional view of an EL structure deployed using UV-curable inks according to the present invention. FIG. 2 is a perspective view of FIG. 1. It will be seen that all layers on FIGS. 1 and 2 are deployed on transfer release film 102. It will be understood, however, that PTF laminates that include the UV-curable inks disclosed herein are not limited to a deployment on transfer release film, and may be deployed directly on destination substrates. It will also be understood, as noted above, that the present invention is not limited to deployment in the form of EL structures.

In the embodiment depicted on FIG. 1, transfer release film 102 is a silicon/PET type film as manufactured by Burkhardt Freeman, part no. 1806C. It will also be understood that transfer release paper, for example, may be used as an alternative to film in embodying item 102. In such embodiments, a serviceable transfer release paper is Aquatron Release Paper as offered by Midland Paper.

All subsequent layers as shown on FIGS. 1 and 2 (and subsequent Figures) are advantageously deployed by screen printing or other printing techniques known in the art. It will be understood, however, that the UV-curable inks are not limited to any particular printing techniques in their deployment. Screen printing is a serviceable selection. In addition, the rapidity of curing times brought about UV-curing also allows other printing techniques to be used. For example, pad printing is available, particularly to assist printing directly to a three-dimensional surface. Alternatively, carousel or roll printing techniques are available as part of a continuous manufacturing process facilitated by the rapid cure times of UV-curable inks.

In the embodiments described on FIGS. 1 and 2, all layers 104 through 116 are advantageously deployed using UV-curable inks. It will also be appreciated, however, that the present invention is not limited to applications in which all layers in a laminate are deployed using UV-curable inks. Applications maybe contemplated within the scope of the invention in which only selected layers are deployed using the UV-curable inks.

There now follows a discussion of first envelope layer 104 as shown on FIGS. 1 and 2. It will be appreciated, however, that the following discussion of first UV-cured envelope layer 104 is equally applicable to and descriptive of second envelope layer 114, also shown on FIGS. 1 and 2.

First envelope layer 104 is deployed onto transfer release film 102. It may be advantageous to deploy first envelope layer 104 in several intermediate layers to achieve a desired overall combined thickness. Deployment of first envelope layer 104 in a series of intermediate layers also facilitates dying or other coloring of particular layers to achieve a desired natural light appearance of the EL structure. As noted above in this disclosure, however, use of UV-curable inks tends to reduce shrinkage in thickness of deployed layers during curing. Use of UV-curable inks thus makes more precise the achievement of a desired overall deployed layer thickness.

In the embodiments depicted on FIGS. 1 and 2, first envelope layer 104 includes a UV-curable urethane acrylate/acrylate monomer such as Nazdar 651818PS. This is a UV-curable urethane ink suitable for screen printing and other printing techniques. The Nazdar 651818PS ink initiates curing and cross-linking when exposed to UV radiation. When cured, this ink is extremely malleable and ductile, and thus exhibits advantageous characteristics to form membranous EL structures as disclosed in concept in parent application METHOD FOR CONSTRUCTION OF ELASTOMERIC ELECTROLUMINESCENT LAMP, Ser. No. 09/173,404. This ink is also chemically stable with other components of an EL structure, and is also further well disposed to be deployed in multiple layers to reach a monolithic final thickness when cured. This ink is also substantially colorless and generally clear, and so layers thereof are further well disposed to receive dying or other coloring treatments (as will be further described below) to provide, when deployed in an EL structure, a laminate whose appearance in natural light is designed to complement its active light appearance in subdued light.

It will be appreciated, however, that the present invention is not limited to enablement by the Nazdar 651818PS product. The scope of the present invention includes any UV-curable product suitable for use as an ink deployed in PTF form.

When embodied as a layer of UV-curable urethane acrylate/acrylate monomer such as Nazdar 651818PS, first envelope layer 104 on FIGS. 1 and 2 is preferably deployed as a series of individual layers in the range of 20 to 40 microns thick. An overall thickness of 50 to 100 microns is generally serviceable for first envelope layer 104 in most applications.

Individual layers on first envelope layer 104 are deployed serially using screen printing or other suitable techniques. When screen printing is used, both an 83 polyester (single twill) screen and a 140 polyester (single twill) screen have been found to give a satisfactory results. Available alternatives to screen printing include pad printing, carousel printing or roll printing.

Once deployed, each individual layer is cured by UV radiation before the next layer is deployed. Curing is preferably done using a conventional UV-curing conveyor, thereby enabling a continuous manufacturing process.

Those of skill in the art will expect that some experimentation and adjustment is required to determine the optimal exposure to UV radiation to achieve a desired layer cure. Variables such as the wavelength and intensity of the UV radiation source, the distance from the source to the layer to be cured, the thickness of the layer to be cured, and the precise UV-curable polymer used will be understood to affect the determination of an optimal exposure time. Such experimentation is normal and known to be expected in any UV-curing conveyor process. By way of example, however, it has been found that a burst of UV radiation for 3 seconds at a wavelength of 360-380 nm imparts approximately 500-600 mJ of intensity, which is satisfactory to cure a layer of Nazdar 651818PS that is approximately 20 microns thick. Serviceable results may be achieved by exposure to a mercury UV lamp, often known in the art as an “H” bulb. A suitable mercury UV lamp is manufactured by UVPS, model no.25CC300, specified by the manufacturer as generating UV radiation at wavelengths of approximately 250 nm to 400 nm. Other sources are available if higher amplitude and power is sought so as to effect UV curing more quickly or on a thicker layer. In such circumstances, serviceable results may be achieved using UV radiation generated by an iron UV lamp, also known in the art as a “D” bulb. A suitable iron UV lamp is manufactured by UVPS, model no. 25CC300I, specified by the manufacturer as also generating UV radiation at wavelengths of approximately 250 nm to 400 nm.

It will be further appreciated that the present invention is not limited to any particular UV radiation source to cure the UV-curable inks described herein. In addition to the mercury UV lamp and the iron UV lamp described above, other examples of suitable UV radiation sources include a gallium UV lamp, an iridium UV lamp or a UV laser. It should be noted that several types of UV lasers are commercially available. Examples include the following types: HeCd (325 nm); Nitrogen (337.1 nm); XeF and Argon ion (351 nm); Nd-YAG 3rd harmonic (355 nm); Argon ion (364 nm); Alexandrite 2nd harmonic (360-430 nm tunable); Ti-sapphire 2nd harmonic (360-460 nm tunable).

Referring back now to FIGS. 1 and 2, it will be seen that first envelope layer 104 is deployed onto transfer release film 102 so as to provide a border 105 clear of the edge of EL system layers 106-112. This is so as to provide a zone on which second envelope layer 114 can bond to completely seal and crosslink the EL system.

In the embodiments illustrated in FIGS. 1 and 2, an EL system is next deployed onto first envelope layer 104. On FIGS. 1 and 2 it will be seen that the EL lamp is being constructed “face down.” It will be appreciated, however, that this is not a limit on the present invention, which may just as easily be constructed “face up.”

In the embodiments of the invention depicted on FIGS. 1 and 2, EL layers 106-112 comprise an electroluminescent system formed by deploying successive UV-cured PTF layers. In one embodiment, EL layers 106-112 each include a urethane carrier compound, thereby optimizing the potential for a membranous structure with monolithic properties throughout. In another embodiment, back electrode layer 112 includes an epoxy carrier compound having improved conductivity characteristics. This alternative embodiment has been found to have comparable membranous properties to the all-urethane embodiment.

In the all-urethane embodiment, EL layers 106-112 combine with first and second envelope layers 104 and 114 to provide an EL structure with membranous and monolithic properties. Moreover, in the exemplary embodiments depicted in FIGS. 1 and 2, some or preferably all of the inks deployed to form EL layers 106-112 are advantageously UV-curable so as to afford the overall EL structure the above-described advantages of UV-curing.

In such a membranous monolithic urethane EL structure, one or more, and advantageously all of the layers comprising translucent electrode layer 106, luminescent layer 108, dielectric layer 110, and back electrode layer 112 are deployed in the form of active ingredients (hereafter also referred to as “dopants”) initially suspended in a UV-curable urethane carrier. It will nonetheless be understood that although one embodiment herein discloses exemplary use of a UV-curable urethane carrier in which all layers are suspended, alternative embodiments may have less than all layers suspended therein.

It will thus be appreciated that in the all-urethane embodiment described in FIG. 1 and also in FIG. 2, when the EL layers 106, 108, 110 and 112 are cured, neighboring urethane layers crosslink both with themselves and with surrounding envelope layers 104 and 114 to bring enhanced monolithic properties to the finished laminate in urethane form. The finished monolithic laminate in urethane form will also be seen to have membranous properties with attendant high flexibility.

Referring again to FIGS. 1 and 2, translucent electrode layer 106 is first deployed onto first envelope layer 104. Translucent electrode layer 106 comprises a UV-curable urethane acrylate/acrylate monomer carrier doped with a suitable translucent electrical conductor in particulate form. In the embodiments illustrated in FIGS. 1 and 2, this dopant is indium-tin-oxide (ITO) in powder form, available for example from Acronium as part number ITO 6699 series. The carrier is available from Allied Photo Chemical, part no. EXGH-AADJ.

In deployment, translucent electrode layer 106 can typically be screen printed using a 196 polyester single twill screen. As noted, however, other types of printing are available, such as pad, carousel or roll printing. In the embodiments described with reference to FIGS. 1 and 2, translucent layer 106 is advantageously built to a layer thickness not exceeding 15 microns. UV-curing may be enabled as described above with respect to first envelope layer 104. A burst of 300 mJ of UV radiation for 3 seconds has appeared sufficient to cure the embodiments of translucent electrode layer 106 described above.

The design of translucent electrode layer 106 must be made with reference to several variables. It will be appreciated that the performance of translucent electrode layer 106 will be affected by not only the concentration of ITO used, but also the ratio of indium-oxide to tin in the ITO dopant itself. In determining the precise concentration of ITO to be utilized in translucent electrode layer 106, factors such as the size of the electroluminescent lamp and available power should be considered. The more ITO used in the mix, the more conductive translucent electrode layer 106 becomes. This is, however, at the expense of translucent electrode layer 106 becoming less translucent. The less translucent the electrode is, the more power that will be required to generate sufficient electroluminescent light. On the other hand, the more conductive translucent electrode layer 106 is, the less resistance EL system 106-112 will have as a whole, and so less the power that will be required to generate electroluminescent light. It will be therefore readily appreciated that the ratio of indium-oxide to tin in the ITO, the concentration of ITO in suspension and the overall layer thickness must all be carefully balanced to achieve performance that meets design specifications. By way of example only to assist in selection of a design for translucent electrode layer 106, it should be noted that the embodiments of translucent layer 106 described above have been observed to cause about a 30% loss in light output, with a corresponding resistance of no more than 3 kOhms per square if the above-suggested Acronium/Allied Photo ink blend is used in a ratio of 7-8 parts ITO to 10 parts carrier by weight.

Returning to FIGS. 1 and 2, it will be understood that front bus bar 107, as illustrated in FIGS. 1 and 2, is deployed on translucent electrode layer 106 to provide electrical contact between translucent electrode layer 106 and a power source (not illustrated). In a the embodiments depicted on FIGS. 1 and 2, front bus bar 107 is placed in contact with translucent electrode layer 106 subsequent to the deployment of translucent electrode layer 106 on first envelope layer 104. It will be nonetheless appreciated that from bus bar 107 may also be deployed on first envelope layer 104 prior to the deployment of translucent electrode layer 106.

Front bus bar 107 is preferably deployed as a UV-cured PTF layer using the same inks and techniques as described below with reference to rear electrode layer 112. Alternatively, front bus bar may be deployed as a thin metallic bar made from, for example, silver or copper. If front bus bar 107 is a thin metallic bar, it is also preferable, although not required, to apply front bus bar 107 to translucent electrode layer 106 prior to curing to allow front bus bar 107 to become part of the monolithic structure of the present invention, thereby optimizing electrical contact between front bus bar 107 and translucent electrode layer 106.

Luminescent layer 108 is then deployed onto translucent electrode layer 106 and over front bus bar 107. Luminescent layer 108 comprises the UV-curable urethane carrier doped with electroluminescent grade encapsulated phosphor. Experimentation has revealed that a suspension containing roughly 55% phosphor to 45% carrier by weight, when applied to a thickness of approximately 38 to 45 microns, results in a serviceable luminescent layer 108. In the embodiments of FIGS. 1 and 2, the carrier is preferably again the Nazdar 651818PS UV-curable urethane ink described above with reference to first envelope layer 104. The phosphor is preferably Osram Sylvania product ANE430 in powder form. Further optional advantages may also be obtained by adding Nazdar product 653545PS to the urethane ink. Nazdar 653545PS is UV-curable urethane acrylate/acrylate monomer having very low viscosity. Adding 653545PS to the 651818PS product has been found to reduce the viscosity of the combined product and thus permit the resulting carrier mixture to be able to receive more powder content. The 653545PS (if used) is blended with the 651818PS in a preferred ratio of about 1 part 653545PS to 10 parts 651818PS by weight. The phosphor is advantageously mixed with the carrier for approximately 10-15 minutes, using a preferred ratio of about 3 parts ANE430 to about 2 parts 651818PS by weight. Mixing should preferably be by a method that minimizes damage to the individual phosphor particles.

It shall be appreciated that the color of the light emitted will depend on the color of phosphor used in luminescent layer 108, and may be further varied by the use of dyes. Advantageously, a dye of desired color is mixed with the carrier prior to the addition of the phosphor. For example, rhodamine may be added to the carrier in luminescent layer 108 to result in a white light being emitted. Amounts of colorizing admixtures will depend on the desired effect.

Experimentation has also revealed that suitable admixtures, such as barium-titanate, improve the performance of luminescent layer 108. Admixtures such as barium-titanate have a smaller particle structure than the electroluminescent grade phosphor suspended in luminescent layer 108. As a result, the admixture tends to unify the consistency of the suspension, causing luminescent layer 108 to go down more uniformly, as well as assisting even distribution of the phosphor in suspension. The smaller particles of the admixture also tend to act as an optical diffuser which remediates a grainy appearance of the luminescing phosphor. Finally, experimentation also suggests that a barium-titanate admixture may actually enhance the luminescence of the phosphor at the molecular level by stimulating the photon emission rate.

The barium-titanate admixture used in the preferred embodiment is the same as the barium-titanate used in dielectric layer 110, as described below. As noted below, a serviceable barium-titanate is available by name in powder form from Certronic in Brazil. In the preferred embodiment, the barium-titanate (when used) is pre-mixed into the carrier after the 653545PS (if used) is blended into the 651818PS, but before phosphor is added. The barium-titanate is preferably added in a ratio of about 1 part barium-titanate powder to 10 parts 651818PS by weight.

When the foregoing ingredients are used to deploy luminescent layer 108, it has been found that the resulting ink prints readily to a 38 micron layer using a 280 polyester single twill screen. Alternatively a more dense 45 micron layer has been obtained using a 230 polyester single twill screen. The deployed layers may then be cured using a 300 mJ burst of UV radiation for about 3 seconds.

It should also be noted that for the embodiments of luminescent layer 108 described immediately above, it is advantageous to print “wet on wet”, or in other words, to repeat the print immediately after the first. It has been found that this technique tends to compact the larger grains of phosphor, thereby further enhancing the phosphor density in the ink.

Returning again now to FIGS. 1 and 2, dielectric layer 110 is deployed onto luminescent layer 108. Dielectric layer 110 comprises an ink including the UV-curable carrier doped with a dielectric in particulate form. In a preferred embodiment, the carrier is again the Nazdar 651818PS UV-curable urethane product, optionally blended with the low viscosity Nazdar 653545PS UV-curable urethane product as described above with reference to luminescent layer 108. When the 653545PS product is used (recommended) in dielectric layer 110, it should be blended in a ratio of about 4 parts 651818PS to about 1 part 653545PS by weight. The dopant in dielectric layer 110 is barium-titanate powder, available by name preferably from Certronic in Brazil (as noted above), or alternatively from Tam Ceramics. When the unitary carrier includes a 20% by weight content of 653545PS product as recommended above, the barium titanate can be added to the carrier in a ratio of about 5 parts barium-titanate to about 3 parts 651818PS by weight.

A serviceable blending technique is first to blend the powder slowly into the carrier. Then, the ink should be “3-roll milled” (as is known in the art) using three separate passes through a 3-roll mill to ensure a very even mix with no agglomerates. This technique enhances the capacitive properties of the resultant ink layer when cured. The higher capacitive properties in turn lead to higher lamp brightness.

If the foregoing “recipe” is followed for dielectric layer 110, it has been found that a single layer deployment of dielectric layer 110 is available in view of the high solids content achievable. It has been found that such a deployed layer tends not to form pin holes because of the high solids content. Advantageously, dielectric layer 110 is deployed at a thickness of about 18 microns using a 305 single twill screen. Again, the layer, once deployed, is then cured with a burst of about 300 mJ of UV radiation for about 3 seconds.

It will be further appreciated that the doping agent in dielectric layer 110 may also be selected from other dielectric materials, either individually or in a mixture thereof. Such other materials may include titanium-dioxide, or derivatives of mylar, teflon, or polystyrene.

Returning once more to FIGS. 1 and 2, back electrode layer 112 is deployed onto dielectric layer 10. In an all-urethane embodiment, back electrode layer 112 comprises an ink including a UV-curable urethane carrier doped with an electrically conductive ingredient such as silver. A suitable ink comprising UV-curable urethane acrylate/acrylate monomer doped with silver is commercially available as Allied Photo Chemicals product EXGH-AADS.

In an alternative embodiment, back electrode layer 112 comprises a UV-curable epoxy-based carrier compound doped with an electrically conductive material such as silver. A suitable ink comprising UV-curable epoxy acrylate/acrylate monomer doped with silver is commercially available as Allied Photo Chemicals product UVAG 0022. It shall be understood, however, that the dopant in back electrode layer 112 may be any electrically conductive material including, but not limited to, gold, zinc, aluminum, graphite and copper, or combinations thereof. It has been found that the epoxy carrier compound gives enhanced conductivity. It is postulated that free radicals in the epoxy carrier compound enhance the conductivity provided by electrically conductive dopant.

With respect to embodiments using either a urethane or epoxy carrier, research has further revealed that layer thicknesses of approximately 8 to 12 microns give serviceable results, although additional layers may be deployed if desired to give additional thickness and conductivity.

Embodiments of back electrode layer 112 may be deployed in 8-12 micron thicknesses using standard screen printing techniques. By way of example, a 305 polyester single twill screen has been found to satisfactorily deploy an 8 micron layer of the UVAG 0022 product described above. After deployment, it has been found that a burst of 800 mJ of UV radiation for a time less than 3 seconds has yielded optimal curing. It has been found that back electrode layer 112 in the preferred embodiment described above has a tendency to “post cure” with time, during which curing period the particles in the layer adhere to one another better. As a result, the resistance of the layer decreases and the mechanical strength of the layer increases as “post cure” progresses.

Turning again to FIGS. 1 and 2, second envelope layer 114 is then deployed onto back electrode layer 112. Optionally, as a precautionary step, EL layers 106-112 may first be tested for performance before sealing with second envelope layer 114.

It will be seen from FIGS. 1 and 2 that EL system layers 106-112 are advantageously deployed leaving border 105 clear. This allows second envelope layer 114 to be deployed to bond to first envelope layer 104 around border 105, thereby (1) sealing the EL system in an envelope so as to isolate the EL system electrically, (2) allowing second envelope layer 114 to crosslink with the ends of cured urethane layers in EL system 106-112, and (3) making the entire laminate substantially moisture proof. As noted above, and according to the invention, second envelope layer 114 is preferably made from the same material, and is preferably manufactured and in the same way as first envelope layer 104. Further, also as noted above, second envelope layer 114 may also be deployed in a series of intermediate layers to achieve a desired thickness.

The final (top) layer illustrated on FIGS. 1 and 2 is an optional adhesive layer 116. As already described, one application of the of the present invention is in the form of a membranous EL structure configured as a transfer affixable to a substrate. In this case, the transfer may be affixed using a heat adhesive, although other affixing techniques may be used, such as contact adhesive. Heat adhesive has the advantage that it may be deployed using the same manufacturing processes as other layers of the assembly, and then the transfer may be stored or stocked, ready to be affixed subsequently to a substrate using a simple heat press technique. In this case, as illustrated on FIGS. 1 and 2, adhesive layer 116 is deployed onto second envelope layer 114.

Of course, it will be apparent that there are other applications of the present invention when embodied in an EL structure is a self-contained component of another product, or deployed directly onto a destination substrate. In such cases, the optional adhesive layer 116 may not be necessary or even desirable.

A further feature illustrated on FIGS. 1 and 2 is the pair of rear contact windows 118A and B. Clearly, in order for electric power to be brought in to energize EL system 106-112, rear contact window 118A is required through adhesive layer 116 and second envelope layer 114 to reach back electrode layer 112. Similarly, a further window is required to reach front bus bar 107 through adhesive layer 116, second envelope layer 114, back electrode layer 112, dielectric layer 110 and luminescent layer 108. This further window is not illustrated on FIG. 1, being omitted for clarity, but may be seen on FIG. 2 as item 118B penetrating all layers through to front bus bar 107 and thereby facilitate the supply of electric power thereto.

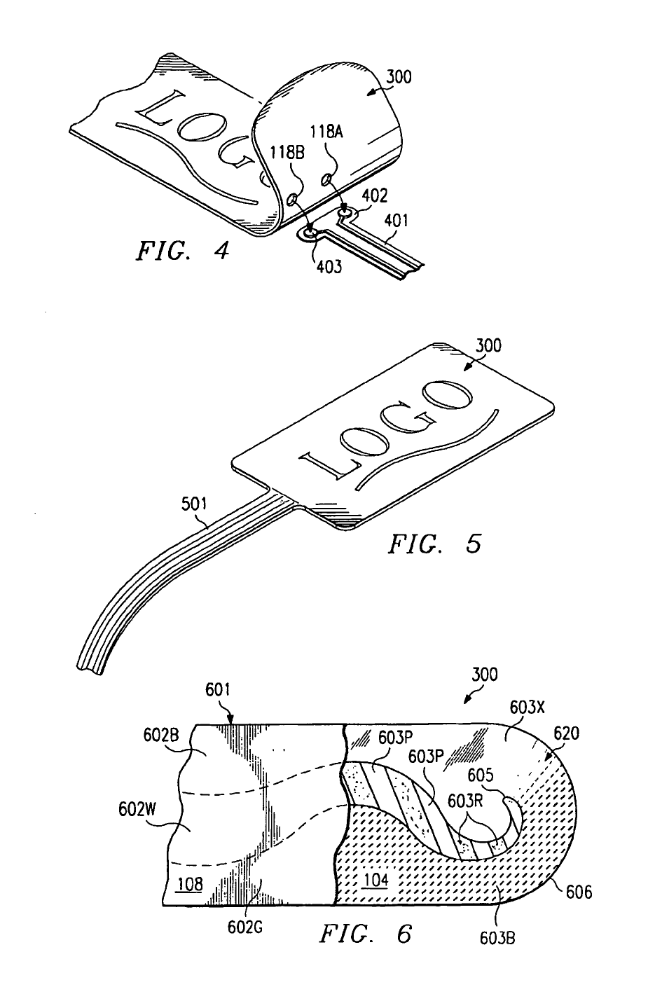

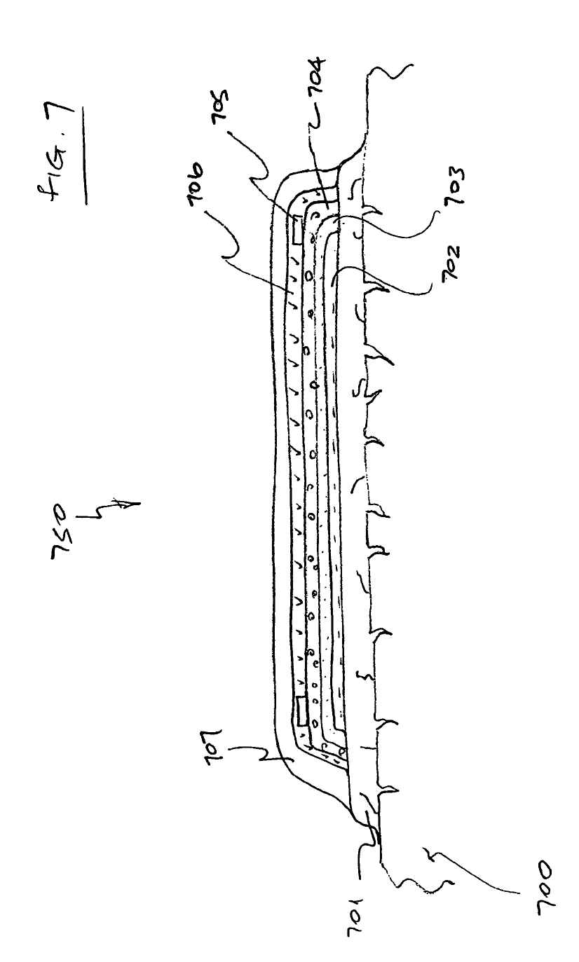

FIG. 3 illustrates the entire assembly as described substantially above after completion and upon readiness to be removed from transfer release film 102. EL lamp 300 (comprising layers and components 104-116 as shown on FIGS. 1 and 2) is being peeled back from transfer release film 102 in preparation for affixation to a substrate. Back and front contact windows 118A and 118B are also shown.

It will also be appreciated (although not illustrated) that the present invention provides further manufacturing economies over traditional EL lamp manufacturing processes when large number of the same design lamp are required. Screen printing techniques allow multiple EL lamps 300 to be constructed simultaneously on one large, even continuous sheet of transfer release film 102. The location of these lamps 300 may be registered on the single sheet of release film 102, and then simultaneously or continuously punched out with a suitable large punch. The individual lamps 300 may then be stored for subsequent use. This advantage of printing multiple lamps 300 on a single or continuous sheet of transfer release film 102 will thus be seen to further leverage the advantage of rapid curing of UV-curable inks using a UV-curing conveyor system as is known in the art.

As noted above, in accordance with the present invention, the front appearance of EL lamp 300 in natural light may also be designed and prepared using dying or other techniques on selected intermediate layers of first envelope layer 104. In accordance with such techniques, FIG. 3 also depicts a first portion of logo 301 being revealed as EL lamp 300 is being peeled back. Features and aspects of a preferred preparation of logo 301 will be discussed in greater detail below.

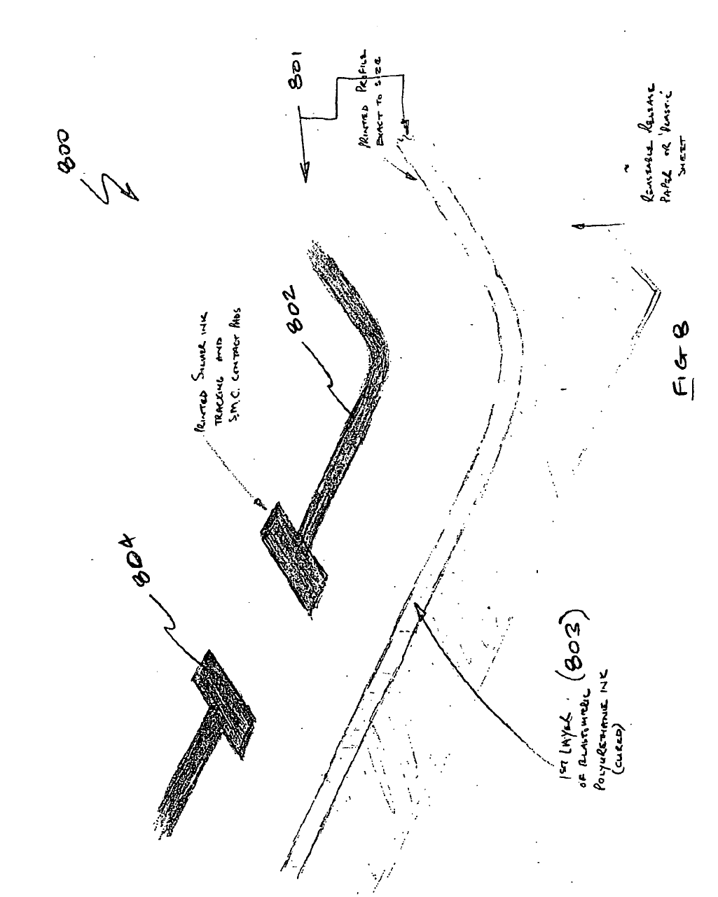

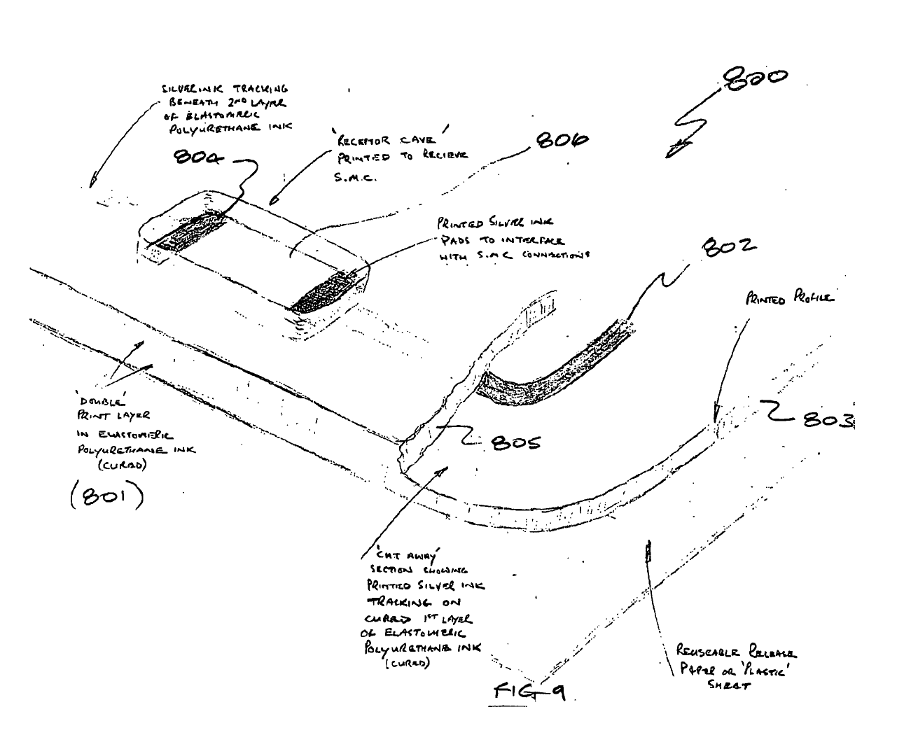

First, however, there follows further discussion of two alternative preferred means for providing electric power to the EL lamp 300. With reference to FIG. 4, EL lamp 300 will be seen right side up and rolled back to reveal back and front contact windows 118A and 118B. Electric power is being brought in from a remote source via flexible bus 401, which may, for example, be a printed circuit of silver printed on polyester, such as is known in the art. Alternatively, flexible bus 401 may comprise a conductor (such as silver) printed onto a thin strip of polyurethane. Flexible bus 401 terminates at connector 402, whose size, shape and configuration is predetermined to mate with back and front contact windows 118A and 118B. Connector 402 comprises two contact points 403, one each to be received into back and front contact windows 118A and 118B respectively, and by mechanical pressure, contact points 403 provide the necessary power supply to the EL system within EL lamp 300.

In a preferred embodiment, contact points 403 comprise electrically-conductive silicon rubber contact pads to connect the terminating ends of flexible bus 401 to the electrical contact points within back and front contact windows 118A and 118B. This arrangement is particularly advantageous when EL lamp 300 is being affixed to a substrate by heat adhesive. The heat press used to affix the transfer to the substrate creates mechanical pressure to enhance electrical contact between the silicon rubber contact pads and electrical contact surfaces on contact points 403 and within contact windows 118A and 118B. Electrical contact may be enhanced yet further by applying silicon adhesive between contact surfaces. Enabling silicon rubber contact pads are manufactured by Chromerics, and are referred to by the manufacturer as “conductive silicon rubbers.” A serviceable silicon adhesive is Chromerics 1030.

A particular advantage of using silicon rubber contact pads is that they tend to absorb relative shear displacement of EL lamp 300 and connector 402. Compare, for example, an epoxy glued mechanical joint. The adhesion between lamp 300 and connector 402 would be inherently very strong, but so rigid and inflexible that relative shear displacement between lamp 300 and connector 402 would be transferred directly into either or both of the two components. Eventually, one or other of the epoxy-glued interfaces (epoxy/lamp 300 or epoxy/connector 402) would likely shear off.

In contrast, however, the resilience of the silicon rubber contact pads disposes the silicon rubber interface provided thereby to absorb such relative shear displacement without degeneration of either the pads or the electromechanical joint. The chance is thus minimized for EL lamp 300 to lose power prematurely because an electrical contact point has suffered catastrophic shear stresses.

An alternative preferred technique for providing electric power to the EL lamp 300 is illustrated on FIG. 5. In this case, when front bus bar 107 and back electrode layer 112 are deployed (as described above with reference to FIG. 1) extensions thereto are also deployed beyond the boundaries of EL lamp 300 and onto trailing printed bus 501. A suitable substrate for trailing printed bus 501 may be, for example, a “tail” of polyurethane that extends from either first or second envelope layers 104 or 114. Additionally, it will be seen that, if desired, the conductors of trailing printed bus 501 may be sealed within trailing extensions of both first and second envelope layers 104 and 114. Electric power may then be connected remotely from lamp 300 using trailing printed bus 501.

It should be noted that the power supplies in a preferred embodiment use battery/invertor printed circuits with extremely low profiles. For example, a silicon chip-based invertor provides an extremely low profile and size. These power supply components can thus be hidden easily, safely and unobtrusively in products on which membranous EL lamps of the present invention are being used. For example, in garments, these power supply components may be hidden effectively in special pockets. The pockets can be sealed for safety (e.g. false linings). Power sources such as lithium 6-volt batteries, standard in the art, will also offer malleability and ductility to enable the battery to fold and bend with the garment. It will be further seen that flexible bus 401 such as is illustrated on FIG. 4, or trailing printed bus 501 such as illustrated on FIG. 5, may easily be sealed to provide complete electrical isolation and then conveniently hidden within the structure of a product.

Turning now to printing techniques, the present invention also discloses improvements in printing techniques to develop EL lamps (including membranous EL lamps) whose passive natural light appearance is designed to complement the active electroluminescent appearance. Such complementing includes designing the passive natural light appearance of the EL lamp to appear substantially the same as the electroluminescent appearance so that, at least in terms of image and color hue, the EL lamp looks the same whether unlit or lit. Alternatively, the lamp may be designed to display a constant image, but portions thereof may change hue when lit as opposed to unlit. Alternatively again, the outer appearance of the EL lamp may be designed to change when lit.

Printing techniques that may be combined to enable these effects include (1) varying the type of phosphor (among colors of light emitted) used in luminescent layer 108, (2) selecting dyes with which to color layers deployed above luminescent layer 108, and (3) using dot sizing printing techniques to achieve gradual changes in apparent color hue of both lit and unlit EL lamps.

FIG. 6 illustrates these techniques. It will be understood that these techniques are generally available to all of the alternative printing processes suggested in this disclosure for deploying UV-curable inks. Such alternative printing processes include screen printing, pad printing, carousel printing and roll printing. All of these alternative printing techniques are well known in the art.

Referring to FIG. 6, a cutaway portion 601 of EL lamp 300 reveals luminescent layer 108. In cutaway portion 601, three separate electroluminescent zones 602B, 602W and 602G have been deployed, each zone printed using an electroluminescent material containing phosphor emitting a different color of light (blue, white and green respectively). As noted, it will be understood that screen printing techniques known in the art may enable the deployment of the three separate zones 602B, 602W and 602G. In this way, various zones emitting various light colors may be deployed and, if necessary, combined with zones emitting no light (i.e. no electroluminescent material deployed) to portray any design, logo or information to be displayed when luminescent layer 108 is energized.

The outward appearance of luminescent layer 108 when energized may then be modified further by selectively colorizing (advantageously, by dying) subsequent layers interposed between luminescent layer 108 and the front of the EL lamp. Such selective colorization may be further controlled by printing down colorized layers only in selected zones above luminescent layer 108.

Referring again to FIG. 6, EL lamp 300 has first envelope layer 104 disposed over luminescent layer 108, and as described above with reference to FIGS. 1 and 2, first envelope layer 104 may be deployed to a desired thickness by overlaying a plurality of intermediate layers. One or more of these layers may include envelope layer material dyed to a predetermined color and deployed so that said colorization complements the expected active light appearance from beneath. A range of pre-colorized Nazdar UV-curable urethane products are available, such as the 3500 series and the 3900 series of products. The result in EL lamp 300 is a desired overall combined effect when the EL lamp is alternatively lit and unlit.

For example, on FIG. 6, suppose that zone 603B is tinted blue, zone 603X is untinted, zones 603R are tinted red and zones 603P are tinted purple. The natural light appearance of EL lamp 300 would be, substantially, to have a red and purple striped design 605 with a blue border 606. Red zones 603R and purple zones 603P would modify the white hue of zone 602W beneath, untinted zone 603X would leave unmodified the beige hue of zone 602B beneath, and blue zone 603B would modify the light green/beige hue of zone 602G beneath to give an appearance of a slightly darker blue. It will be appreciated that the blue tint in zone 603B may be further selected so that, when combined with the green of zone 602G beneath, the natural light appearance is substantially the same blue.

When EL lamp 300 was energized, however, zones 603R, 603P and 603X would remain red, purple and blue respectively, while zone 603B would turn turquoise as the strong green phosphor light from beneath was modified by the blue tint of zone 603B. Thus, an exemplary effect is created wherein part of the image is designed to be visually the same whether membranous EL lamp 300 is lit or unlit, while another part of the image changes appearance upon energizing.

It will thus be appreciated that limitless design possibilities arise for interrelating the lit and unlit appearances of the lamp by printing down various colorized phosphor zones in combination with various tinted zones above. It will be understood that such lit/unlit appearance design flexibility and scope is not available in traditional EL manufacturing technology, wherein it is difficult to print variously colored “zones” with precision, or as intermediate layers within a monolithic thickness.

It will be further emphasized that in the tinting technique described above, fluorescent-colored dyes are advantageously blended into the material to be tinted, in contrast to use of, for example, a paint or other colorizing layer. Such dying facilitates achieving visually equivalent color hue in reflected natural light and active EL light. Color blending may be enabled either by “trial and error” or by computerized color blending as is known in the art more traditionally, for example, with respect to blending paint colors.

With further reference to FIG. 6, there is further illustrated a transition zone 620 between zones 603B and 603X. It is intended that transition zone 620 represents a zone in which the darker blue hue of zone 603B (when EL lamp 300 is energized) transforms gradually into the lighter blue hue of zone 603X.

It is standard in the print trade to “dot print.” Further, this “dot printing” technique will be understood to be easily enabled by screen printing. It is known that “dot printing” enables the borders of two printed neighboring zones to be “fused” together to form a zone in apparent transition. This is accomplished by extending dots from each neighboring zone into the transition zone, decreasing the size and increasing the spacing of the dots as they are extended into the transition zone. Thus, when the dot patterns in the transition zones are overlapped or superimposed, the effect is a gradual change through the transition zone from one neighboring zone into the next.

It will be understood that this effect may easily be enabled on the present invention. With reference again to FIG. 6, a dyed layer providing a particular hue in zone 603B may be deployed with dots extending into transition zone 620 where said dots reduce size and increase spacing as they extend into transition zone 620. A dyed layer providing a particular hue in zone 603X may then be deployed on top with dots extending into transition zone 620 in a reciprocal fashion. The net effect, in both natural and active light, is for transition zone 620 to exhibit a gradual transformation from one hue to the next.

It will be appreciated that the foregoing embodiments, especially with reference to FIGS. 1 and 2, have been described as a PTF laminate in the exemplary form of an EL structure built up on transfer release film 102. It will nonetheless be appreciated that the UV-curable inks disclosed herein are not limited to deployment on transfer release film 102, but may also be deployed directly on to a destination or target substrate. FIG. 7 illustrates such a deployment on a porous and/or fibrous substrate 700, such as cloth, leather, fabric or any other surface having a porous or fibrous character. In the case of FIG. 7, it will be seen that exemplary use is made of an EL lamp 750 as in earlier Figures for purposes of illustrating embodiments of the invention. In contrast to FIGS. 1 and 2, however, EL lamp 750 in FIG. 7 is optimally built “face up” instead of “face down” so that when energized, it will emit light against a background of substrate 700.

With reference to FIG. 7, base envelope layer 701 is deployed directly onto substrate 700 in the manner described above with respect to first envelope layers 104 on FIGS. 1 and 2. In the embodiment of FIG. 7, base envelope layer 701 comprises a UV-curable urethane ink such as the Nazdar 651818PS product described above. Base envelope layer 701 is advantageously UV-cured after deployment.

It will be appreciated that additional intermediate layer deployments of base envelope layer 701 may be needed to achieve a final layer thickness that has integrated and anchored properly with the porous or fibrous substrate 700, and that further provides an electrically secure non-porous and non-fibrous surface upon which further layers may be deployed. Those of skill in the art will expect that some experimentation will be required to select an ink viscosity and an overall thickness of base envelope layer 701 that are compatible with substrate 700 material, when dealing particularly with differing porosities or fibrousnesses. By way of example, it has been found that Nazdar 651818PS may need to be deployed to an overall thickness of 20-50 microns to achieve proper anchoring, electrical security, and isolation of pores and fibers.

It should also be borne in mind particularly when working with a fibrous substrate 700, care should be taken to try to prevent any fibers from penetrating through base envelope layer 701. It will be appreciated that when layers are deposited on top of base envelope layer 701, any fibers poking through base envelope layer 701 will tend to undermine the performance of those overlying layers.

With further reference to FIG. 7, EL lamp 750 is now built up by deploying successive PTF layers using the UV-curable inks described above with reference to FIGS. 1 and 2. Rear electrode layer 702 is deployed on base envelope layer 701 in the manner described above with reference to rear electrode layer 112 on FIGS. 1 and 2. Dielectric layer 703 is then deployed on rear electrode layer 702 in the manner described above with reference to dielectric layer 110 on FIGS. 1 and 2. Luminescent layer 704 is then deployed on dielectric layer 703 in the manner described above with reference to luminescent layer 108 on FIGS. 1 and 2 (although in an alternative embodiment bus bar 705 may also be deployed on translucent electrode layer 706). Bus bar 705 is then deployed on luminescent layer 704 in the manner described above with reference to front bus bar 107 on FIGS. 1 and 2. Translucent electrode layer 706 is then deployed on luminescent layer 704 and over bus bar 705 in the manner described above with reference to translucent electrode layer 106 on FIGS. 1 and 2. Top envelope layer 707 is then deployed on top of translucent electrode layer 706 in the manner described above with reference to second envelope layer 114 on FIGS. 1 and 2. It will be seen on FIG. 7 that analogous to item 105 on FIGS. 1 and 2, border portion 708 has been left on base envelope layer 701 to allow the deployment of top envelope layer 707 to contact, crosslink and seal with base envelope layer 701 and the ends of intervening layers 702-706. In this way, EL lamp 750 on FIG. 7 is an EL structure that is integrated and anchored directly to porous and/or fibrous substrate 700. The layers in EL lamp 750 will preferably all have been UV-cured to optimize manufacturing advantages and to bring about other related benefits as disclosed above.

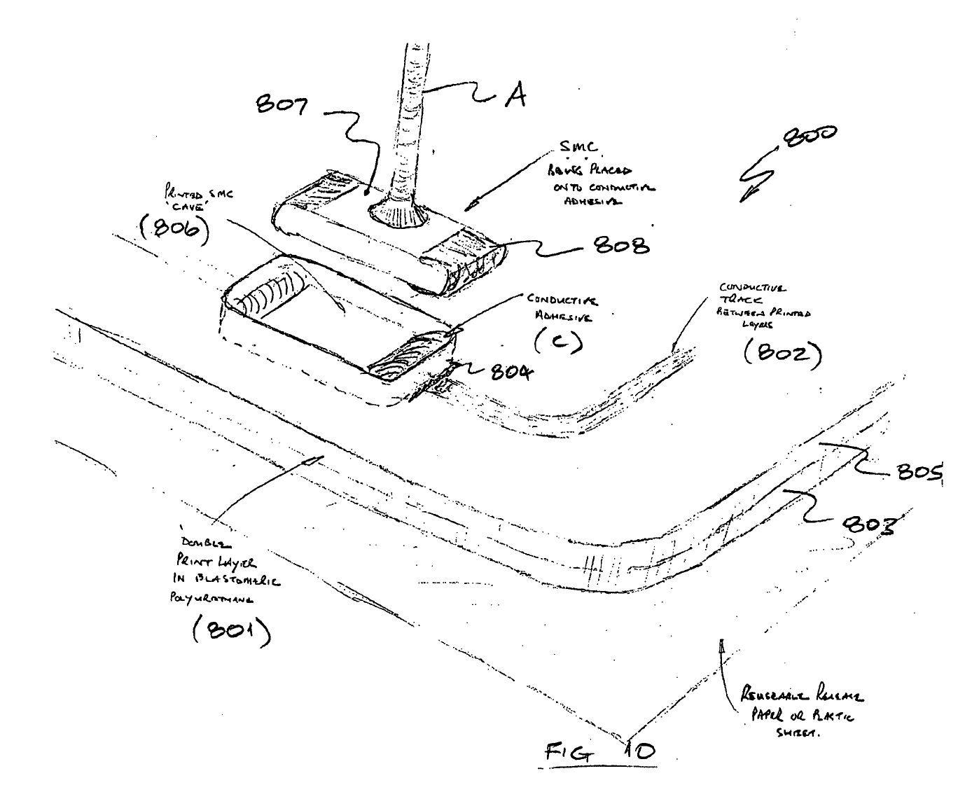

A further embodiment for the UV-curable inks disclosed herein is illustrated in FIGS. 8 through 14. In this embodiment, the inks are advantageously deployed as a PTF laminate enabling flexible printed circuitry. It will be seen from FIG. 8 that circuitry 800 comprises a laminate of layers 801. These layers 801 comprise conductive pathways 802 that are deployed generally between intervening insulating portions 803. It will be understood that insulating portions 803 will preferably give good electrical isolation to conductive pathways 802. However, as will be described in more detail below, it will also be readily appreciated that in certain designs it may be advantageous for insulating portions 803 to be substituted for layers, or portions thereof, that provide less than complete electrical isolation, so as to create, for example, resistive, dielectric, inductive or semiconductive pathways between conductive pathways 802.

Circuitry 800 is advantageously deployed using the techniques and UV-curable inks described herein. In this way, circuitry 800 may be constructed as a membranous and monolithic structure, thereby gaining the attendant advantages discussed above. As a general matter, it will be understood that successive layers 801 may be deployed and UV-cured using the above described inks so as to construct both EL and non-EL laminates benefiting from all of the advantages of UV-curing described herein. In fact, FIGS. 8 through 14 will be discussed with respect to a preferred embodiment including UV-curable inks as described above. It will nonetheless also be appreciated that the flexible circuitry described herein is in no way limited to deployment using UV-curable inks. Those in the art will understand that circuitry 800 on FIGS. 8 through 14 may also be constructed using conventional inks, printing techniques and curing techniques, including those described, for example, commonly-owned U.S. Pat. Nos. 5,856,029 and 5,856,030.

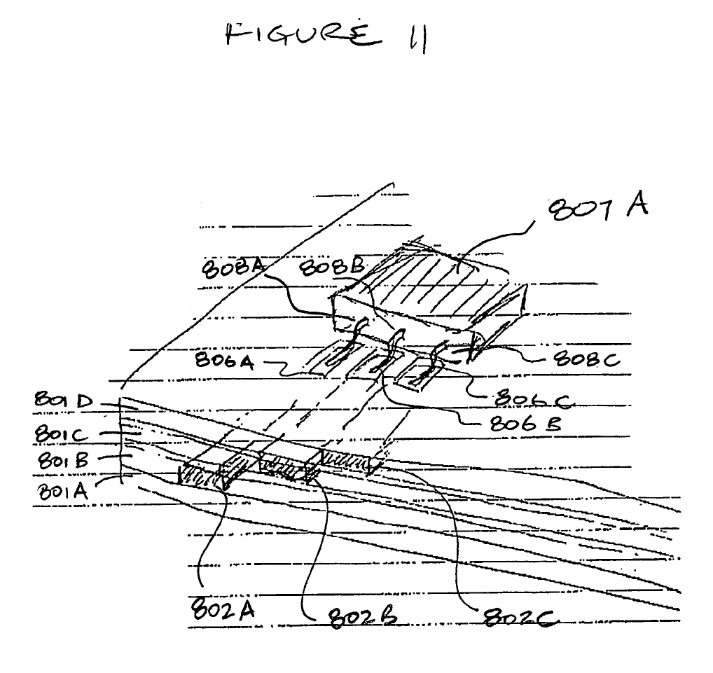

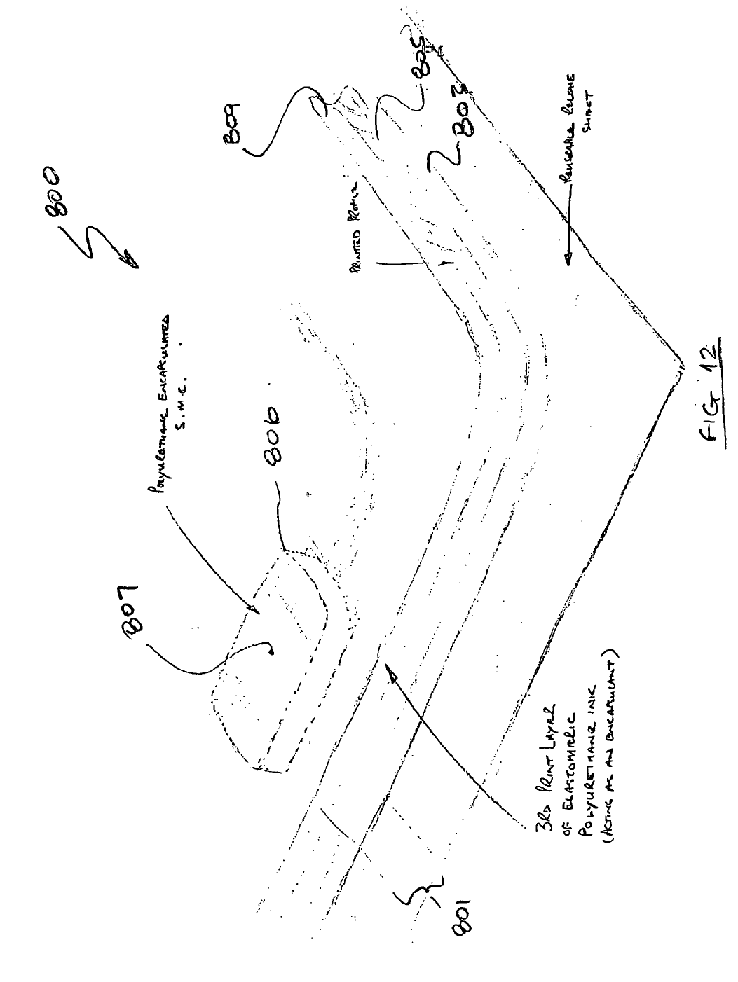

It will also be appreciated that the individual layers 801 of circuitry 800 on FIGS. 8 through 14 may be individually deployed to effectuate any desired layout of electrical pathways, whether isolated, connected, fully conductive or semiconductive, resistive, capacitive, inductive and so on. The selection of inks and the pattern in which they are deployed in each layer 801 will determine the character and “geography” of the electrical pathways created by that layer. Further, as layers 801 are deployed upon each other, electrical pathways from layer to layer may be designed to join or interact with each other electrically, so as to create a three-dimensional character and “geography” of circuitry 800 as a whole. Moreover, it will be appreciated that, as shown on FIGS. 9 and 10, portions of a layer 801 may be designed to be left open (undeployed) in the design of the layer. Successive layers 801 with such open portions thus create apertures in the laminate into which surface mounted components (“SMCs”) may be connected to add functionality to circuitry 800. Such SMCs may include, for example, resistors, inductors, capacitors, transformers, semiconductors or even integrated circuits. The overall effect is for circuitry 800 to become a three-dimensional “nest” of electrical pathways connecting printed components and SMCs.

The foregoing possibilities for circuitry 800 are now discussed in more detail with reference to FIGS. 8 through 14. In FIG. 8, it will be seen that layer 801 includes a first insulating layer 803 onto which conductive pathways 802 are deployed. It will be appreciated that a purpose of first insulating layer 803 is to seal and insulate conductive pathways 802 from the outside environment. It will also be appreciated that if portions of conductive pathways 802 are desired to be exposed, then selected portions of first insulating layer 803 should be left undeployed or masked to allow conductive pathways 802 to be so exposed.

In an embodiment using UV-curable inks, first insulating layer 803 may be deployed using a UV-curable urethane acrylate/acrylate monomer such as Nazdar 651818PS, as described above with respect to first and second UV-cured envelope layers 104 and 114 as shown on FIGS. 1 and 2. Conductive pathways 802 are then deployed onto first insulating layer 803 using a UV-curable ink doped with silver or other conductor. For example, Allied Photo Chemicals product UVAG 0022 may be used to deploy conductive pathways 802. This ink is described in more detail above with respect to back electrode layer 112 as depicted on FIGS. 1 and 2.

Although only one or two conductive pathways 802 are shown on FIG. 8, it will be appreciated that within the size limits of layer 801, any number of conductive pathways 802 may be deployed according to a predetermined design. It will also be seen on FIG. 8 that SMC contact pads 804 may be printed, where desired, at preselected locations within conductive pathways 802. It will be understood that a purpose for SMC contact pads 804 is ultimately for SMCs (not illustrated on FIG. 8) to make contact with conductive pathways 802 during later phases of construction.

Turning now to FIG. 9, it will be seen that second insulating layer 805 has now been deployed over first insulating layer 803, conductive pathways 802 and SMC contact pads 804. Again, in an embodiment using UV-curable inks, second insulating layer 805 is deployed using a UV-curable ink such as the above-described Nazdar 651818PS. It will be further seen that aperture 806 is left undeployed in second insulating layer 805 to expose contact pads 804 on first insulating layer 803 beneath. As noted, this is ultimately to allow SMCs (not illustrated on FIG. 9) to penetrate second insulating layer 805 and make contact with conductive pathways 802 on first insulating layer 803 via contact pads 804.

For purposes of clarity only, no conductive pathways are shown as deployed on top of second insulating layer 805 on FIG. 9. It will be understood, however, that in practice, as many conductive pathways may be deployed on top of second insulating layer 805 as space and design limitations permit. Again, in a UV-curable embodiment, a UV-curable ink doped with silver or other conductor, such as Allied Photo Chemicals product UVAG 0022 may be used. It will be further appreciated that, if desired according to design, such conductive pathways deployed on second insulating layer 805 maybe connected to conductive pathways 802 on first insulating layer 803 at selected, predesigned junction points. Such junction points will be understood to be implemented by deploying a conductive pathway ink over an aperture 806 in second insulating layer 805 so as to allow conductive contact with a conductive pathway 802 deployed beneath on first insulating layer 803.

Turning now to FIG. 10, it will be seen that SMC 807 is being deployed in aperture 806. It will be appreciated that applicator A on FIG. 10 is temporary and is used to assist deployment of SMC 807 into aperture 806. It would be intended that applicator A would be removed after deployment of SMC 807 into aperture 806. SMC 807 provides contact points 808 for ultimate conductive contact with exposed contact pads 804 on first insulating layer 803. As shown on FIG. 10, conductive adhesive C may be used to improve the contact between contact points 808 and contact pads 804. The conductive adhesive C also enhances the robustness of the deployment of SMC 807 in aperture 806.

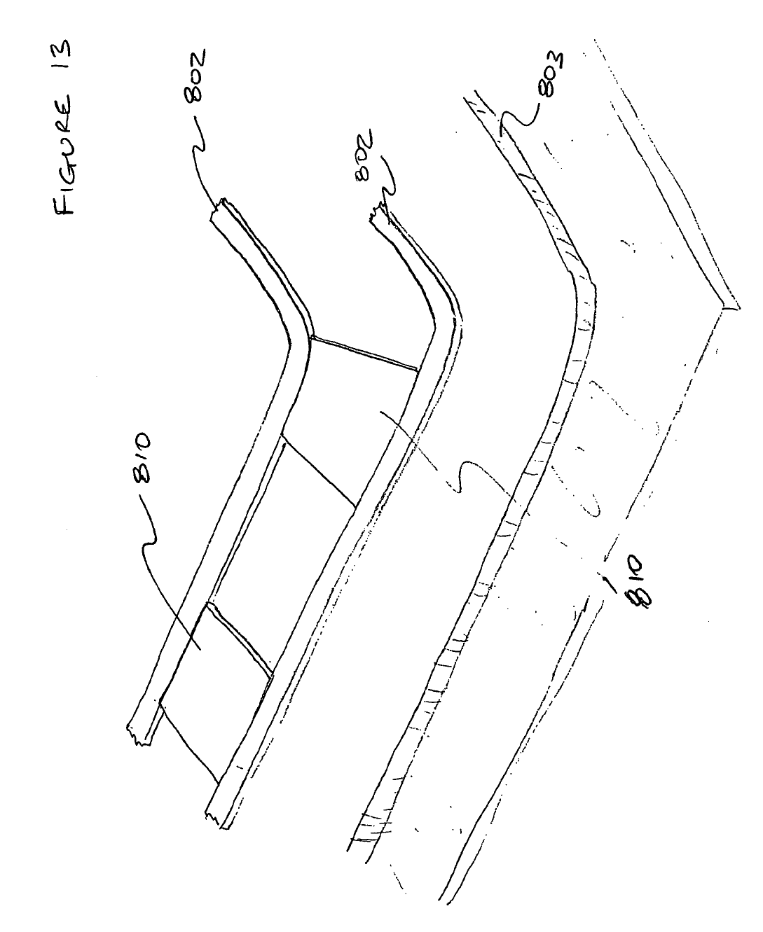

FIG. 11 depicts a further variant of the embodiment illustrated on FIG. 10. In the embodiment of FIG. 11, it will be seen that SMC 807A is deployed on top layer 801D in the 4-layer laminate 801A through 801D. In FIG. 11, connectors 808A, B and C from SMC 807A pass through apertures 806A in layers 801B through 801D so as to make conductive contact with conductive pathways 802A, B and C deployed thereon. Thus, in the embodiment of FIG. 11, in contrast to the embodiment of FIG. 10, smaller apertures 806A, B and C are required, and may perhaps be located less precisely than their counterpart on FIG. 10. It will be further understood that once SMC 807A is deployed on layer 801D and connectors 808A, B and C are established, a further layer (not illustrated) may be deployed to fill apertures 806A, B and C and to seal SMC 807A in the manner described below with respect to FIG. 12.

With reference now to FIG. 12, and with further reference to FIGS. 8 through 10, it will be seen that third insulating layer 809 has now been deployed over second insulating layer 805. Again, in an embodiment using UV-curable inks, third insulating layer 809 is deployed using a UV-curable ink such as the above-described Nazdar 651818PS. FIG. 12 shows that third insulating layer 809 has now sealed SMC 807 within aperture 806 in second insulating layer 805.

Again, for purposes of clarity only, no conductive pathways are shown as deployed on top of third insulating layer 809 on FIG. 12. It will be understood, however that in practice, as also noted above with respect to second conductive layer 805, as many conductive pathways may be deployed on top of third insulating layer 809 as space and design limitations permit. Again, in a UV-curable embodiment, a UV-curable ink doped with silver or other conductor, such as Allied Photo Chemicals product UVAG 0022 may be used. It will be further appreciated that, if desired according to design, such conductive pathways deployed on third insulating layer 809 may be connected to conductive pathways on second insulating layer 805 and/or on first insulating layer 803 at selected, predesigned junction points. Such junction points will be understood to be implemented by deploying a conductive pathway ink over an aperture in third and/or second insulating layers 809 and 805 so as to allow conductive contact with a conductive pathway deployed beneath.

In this way, it will be seen that a laminate of three-dimensionally interconnected and “nested” conductive pathways and SMCs may be constructed to implement a design of flexible circuitry. Although only three layers 803, 805 and 809 have been shown and described with respect to FIGS. 8 through 12, it will be understood that additional layers may be deployed as required to meet a particular flexible circuitry design. It will also be understood that the flexible circuitry may be deployed using inks that give membranous and monolithic properties to the cured laminate.

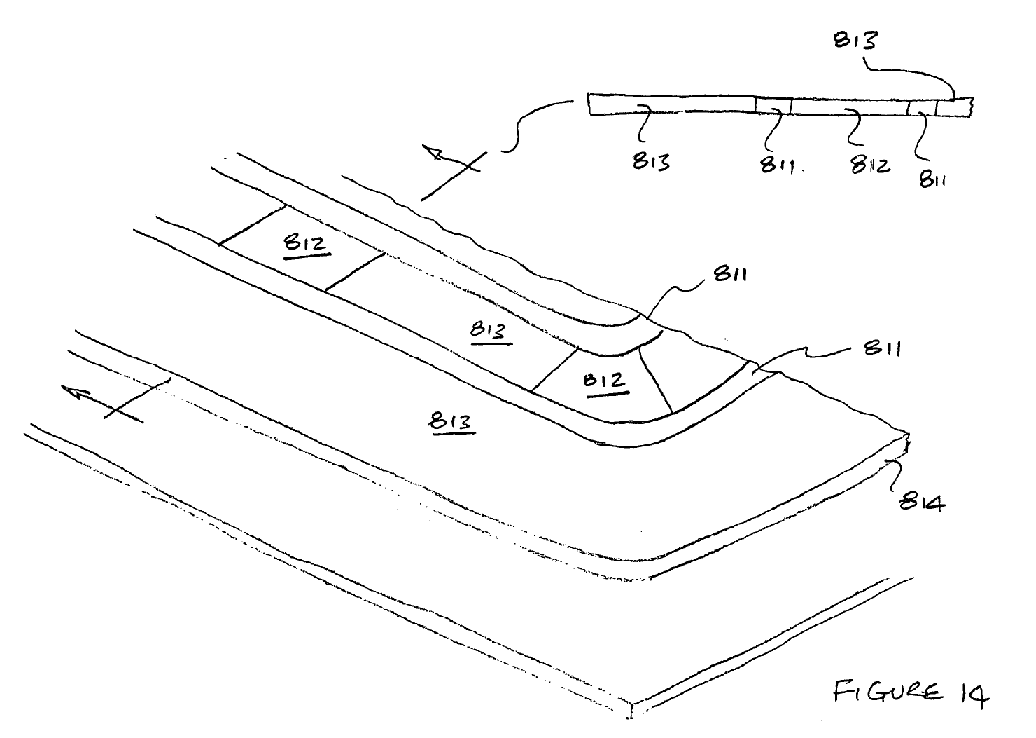

Moreover, it will be appreciated that other aspects and features are available within the scope of the flexible circuitry described herein. For example, the flexible circuitry is not limited to the deployment of “hardware components” in the form of SMCs between layers as described above with reference to FIGS. 8 through 12. Turning to FIG. 13, an example is shown of deployment of an ink in an active zone 810 between conductive pathways 802. It will be appreciated that the deployment of active zone 810 and conductive pathways 802 are still essentially “sandwiched” within the structure of insulating layers 803, or 805, or 809, for example, as depicted on FIGS. 8 through 13. Looking at FIG. 13, however, it will be understood that active zone 810 comprises and ink whose cured deployment has a predetermined electrical function, such as resistance, capacitance, inductance, semiconductivity or some other predetermined function. As such, active zone 810, when cured, functions as a flexible circuitry “component” deployed in layer form. Multiple active zones 810 may be deployed on preselected layers (or as conductively connected between preselected layers) so as to enrich the processing functionality of the flexible circuitry. Moreover, active zones 810 may be used in conjunction with SMCs to achieve an overall design.

It will be appreciated that flexible circuitry is not limited to any particular embodiment of active zone 810. Those in the art will be able to design inks that, when deployed and cured, will fulfill the design criteria for a particular “component” in a specific location. Such inks are well known in the art. By way of example, it will be understood that barium titanate inks, such as are used to deploy dielectric functionality in electroluminescent structures, would also be useful as inks in deployment of active zones 810 as shown on FIG. 13. Again, in a UV-curable embodiment, a UV-curable urethane ink doped with barium titanate may be used. Reference is made to the discussion above of dielectric layer 110 as shown on FIGS. 1 and 2. Inks such as are described with respect to dielectric layer 110 may be used to deploy active zones 810 as shown on FIG. 13 having, for example, capacitive or resistive properties. Parameters such as dopant properties, dopant concentration, carrier properties, layer thickness and zone size and shape will be understood to affect the overall electrical properties of a particular deployed and cured active zone 810. Those in the art would expect to have to engage in some experimentation to match a design of an active zone 810 with desired “component” properties.

The flexible (and if desired, membranous) nature of the circuitry described above lends itself to us in applications where conventional flat circuitry is not optimal. For example, space-starved items such as interior lighting, dashboards, consoles, roof linings, head restraints and cellular telephones often have to be designed to accommodate conventional circuitry. Three-dimensional deployment of flexible circuitry as disclosed above would be particularly suited to these devices, where the circuitry could be adapted three-dimensionally to suit available space. Indeed, in some applications it might be further advantageous to deploy the layers of the above-disclosed flexible circuitry directly onto three-dimensional substrates such as the internal surfaces of dashboards, consoles, roof linings, head restraints, cell phones and the like.

A further application of the flexible circuitry disclosed herein is on “smart” clothing and other apparel, footwear, headgear and raiment. The future holds numerous possibilities for garments (such as headgear, clothing and footwear) onto which flexible (and advantageously membranous) circuitry may be deployed. Computers and other processors may be deployed in or on military or law enforcement apparel to enable functionality such as global positioning systems, communications or information displays. There are analogous civilian applications. The fashion and entertainment industries suggest many additional uses for flexible circuitry.

It will be further understood that flexible circuitry as disclosed herein may also include integral zones having electroluminescent functionality. Those in the art will appreciate that consistent with the above disclosure, certain zones of particular layers may be deployed so that when energized, they combine to electroluminesce. This EL functionality is useful when integral with other flexible circuitry having non-EL functionality. The monolithic potential for flexible circuitry designs as described herein will be further seen to add robustness to flexible or membranous circuitry having both EL and non-EL functionality integrally on board.

FIG. 14 illustrates a further variant of the flexible circuitry disclosed herein. It will be appreciated that in the embodiments depicted in FIGS. 8 through 13, conductive pathways 802 and active zones 810 are deployed on top of first, second and third insulating layers 803, 805 and 809. In the embodiment depicted on FIG. 14, however, conductive pathways 811, active zones 812 and insulating zones 813 are all deployed next to each other to form a single, multi-function layer 814. It will be appreciated that this technique brings additional advantages to the flexible circuitry. First, the overall thickness of the final flexible circuitry will potentially be thinner, suggesting additional flexibility. Second, the use of multi-function layers 814 such as shown on FIG. 14 facilitates cross-layer connectivity and functionality without the need for apertures in layers. It will be understood that multi-function layers 814 such as shown on FIG. 14 may be deployed either in combination with other neighboring multi-function layers, and/or in combination with neighboring “traditional” layers such as first, second and third insulating layers 803, 805 and 809 as depicted on FIGS. 8 through 13. Either way, neighboring layers maybe designed using selected multi-function layers 814 so that conductive pathways 811, active zones 812 and insulating zones 813 may be designed into the flexible circuitry with a dimension that is not limited to the general plane of the deployed layer.

PTF Substrate in Printed Form for Electronic Circuits and Component Support

1) PTF Substrate in printed form for Electronic Circuits and Components support.

2) A membranous support medium—printed onto reusable release carrier sheet—for conductive ink tracking to allow full “Printed circuit” performance.

3) The printed PTF layers allowing “multi layer” capability, enhanced by the ability to print “receptor caves” for SMC component fit—which can then be encapsulated to provide a complete homogeneous structure.

4) Complete membranous keyboards can be “assembled” in PTF multi layer structures in durable polyurethane. This will include layer coloring graphics and lighting.

5) Auto interior lighting —legend and colored graphics will be in the form of an membranous “mat” which can be formed three dimensionally, conforming to the contours within the dashboard and center console system. Also roof linings, head restraints, etc.

6) Smart clothing.

Category: Advanced Printed Circuitry Technology.

An all-printed membranous support medium or substrate. Each layer undergoes curing operation. Capable of full circuit tracking and component installation. The all-printing technique allows “instant” substrate profile format as well as local thickness changes. Being suitable for sections to fld or “concertina” for compact printed circuit assembly. The all printing technique builds layer by layer commencing with a “base” print of membranous polyurethane ink on a suitable reusable release sheet or roll. This initial layer can then be overprinted with conductive circuit tracking carrying the main circuit. Additional printing can then, (if required), install resisters, capacitors, etc. And EL lighting.

The following polyurethane ink layers overprint a significant part of the tracking but leaves areas vacant producing “component caves” for subsequent installation of SMC including ICs. Adhesive is then placed in position on the printed pads and the components are installed into the “caves”.

The components, SMC's and IC are either cured at this stage or the circuit can be overprinted with a capping layer of polyurethane to environmentally seal the printed circuit.

Advance polyurethane ink formulation can be combinations of the following.

1) Single component, heat cured optically clear ink.

2) Double component, i.e. base and catalyst, heat cured, optically clear ink.

3) Multi-component, heat cured, optically clear ink.

4) Single component, ultra violet cured, optically clear ink.

5) Multi-component, ultra violet cured, optically clear ink.

Advantageously the ink formulations would be thixotropic which would greatly improve the formulation of printed “caves” to house SM components. Some layering structures would benefit from “free travelling” ink formulation to facilitate infilling of SM components secreted in caves.

Print Format/Layer Formation

The membranous polyurethane (EP) printed “film” would be developed into a “printed circuit” suing a re-usable substrate release film based on PTFE sheeting, silicone treated paper, fiberglass or cloth or similar releasable layered material.

Printed layers of polyurethane ink would be built up layer by layer with either heat curing or ultra violet curing or a combination of both. A suitably membranous base “film” would be produced before the first layer of circuitry was applied with silver ink. These initial circuits would carry suitably printed pads to receive SMC if required. Alternating the printed silver tracking would be formatted to become an Membranous Membranous keyboard. The subsequent layering of the (EP) printed “film” would leave areas deficient in ink to allow “receptor holes” or “caves” in positions where SMC would later be placed. As these layers were cured, the (EP) film on its substrates film would be moved to a SMC “pick and place” machine for SMC adhesion fit and followed by placement of SMC's. Following SMC curing and testing, the (EP) film would be returned to the print machine and overcoating (EP) films would be applied by further print stages. Multi-layering can take place if the circuit density requires or if space limitations demand that a compact structure is required.

Membranous Polyurethane EL Lamp

If a combination of circuitry and EL Lighting is required within a single structure, the EL Lamp print stage, previously describes in (patent application) cab be applied at the given stages at the printed silver circuit layer or beyond. SMC component fit can include the ICs and drive circuit required to power the EL Lamp, (from a suitable DC supply) all situated within the membranous envelope/Membranous Polyurethane envelope.

Printed within the Membranous Structure can be graphics representing a keyboard fascia, graphics for advertising or special lighting applications. Multi-layers if color or data can be printed with or without back lighting using printed EL.

Membranous Polyurethane Membranous Keyboards can contain SMC, LED components suitably placed as indicators within the keyboard layers as previously described this can be interspaced with EL lighting when both are required.

Although the present invention and its advantages have been described in detail, it should be understood that various changes, substitutions and alterations can be made herein without departing from the spirit and scope of the invention as defined by the appended claims.

I claim:

1. A method for constructing a PTF laminate, comprising:
(a) deploying selected PTF layers in the laminate using UV-curable inks; and
(b) curing the UV-curable ink layers via exposure to UV radiation.

2. The method of claim 1, in which the UV-curable inks are selected from the group consisting of
(a) UV-curable urethane acrylate/acrylate monomers; and
(b) UV-curable epoxy acrylate/acrylate monomers.

3. The method of claim 1, in which the PTF laminate includes EL layers, the EL layers predesigned to combine to electroluminesce when energized;
and in which selected EL layers are deployed using a UV-curable urethane ink and are cured via exposure to UV radiation.

4. The method of claim 1, in which the PTF laminate, when cured, has membranous properties.

5. The method of claim 2, in which the PTF laminate, when cured, has membranous properties.

6. The method of claim 3, in which the PTF laminate, when cured, has membranous properties.

7. The method of claim 1, in which selected neighboring layers in the PTF laminate cure to form a monolithic structure.

8. The method of claim 2, in which selected neighboring layers in the PTF laminate cure to form a monolithic structure.

9. The method of claim 3, in which selected neighboring layers in the PTF laminate cure to form a monolithic structure.

10. The method of claim 1, in which the PTF laminate is constructed onto a temporary substrate, and in which the method further comprises:
(c) removing the temporary substrate.

11. The method of claim 2, in which the PTF laminate is constructed onto a temporary substrate, and in which the method further comprises:
(c) removing the temporary substrate.

12. The method of claim 3, in which the PTF laminate is constructed onto a temporary substrate, and in which the method further comprises:
(c) removing the temporary substrate.

13. The method of claim 1, in which the PTF laminate is constructed directly onto a final destination substrate.

14. The method of claim 2, in which the PTF laminate is constructed directly onto a final destination substrate.

15. The method of claim 3, in which the PTF laminate is constructed directly onto a final destination substrate.

16. The method of claim 13, in which the final destination substrate is a three-dimensionally shaped surface.

17. The method of claim 14, in which the final destination substrate is a three-dimensionally shaped surface.

18. The method of claim 15, in which the final destination substrate is a three-dimensionally shaped surface.

19. The method of claim 13, in which the final destination substrate is porous and/or fibrous.

20. The method of claim 14, in which the final destination substrate is porous and/or fibrous.

21. The method of claim 15, in which the final destination substrate is porous and/or fibrous.

22. The product of the method according to any of claims 1 to 21.

23. A PTF laminate of serially deployed layers, each layer comprising a cured ink, the PTF laminate comprising:
insulating zones deployed in PTF layer form; and
conductive pathways deployed in PTF layer form;
the insulating zones and the conductive pathways cooperatively deployed so as to form, when all layers are cured, a predetermined circuitry of said conductive pathways.

24. The laminate of claim 23, further comprising:
SMCs, the SMCs deployed into apertures in the PTF layers and coupled to conductive pathways deployed in PTF layers;
the SMCs and the insulating zones and the conductive pathways cooperatively deployed so as to form, when all layers are cured, a predetermined circuitry of said conductive pathways and SMCs.

25. The laminate of claim 23, further comprising:
active zones deployed in PTF layer form, the active zones including cured inks giving predesigned electrical functionality to said active zones;
the active zones and the insulating zones and the conductive pathways cooperatively deployed so as to form, when all layers are cured, a predetermined circuitry of said conductive pathways and active zones.

26. The laminate of claim 23, in which the PTF laminate, when cured, has membranous properties.

27. The laminate of claim 23, in which selected neighboring layers in the PTF laminate cure to form a monolithic structure.
